(19) United States
(12) Patent Application Publication
(10) Pub. No.: US 2002/0120627 A1
(43) Pub. Date: Aug. 29, 2002

(54) Virtual document organizer system and method

(76) Inventor: Jeffrey W. Mankoff, Dallas, TX (US)

Correspondence Address: William D. McSpadden, BAKER & McKENZIE, Suite 2300, 2001 Ross Avenue, Dallas, TX, 75201, US

(21) Appl. No.: 10/081,257

(22) Filed: Feb. 22, 2002

Related U.S. Application Data
(63) Continuation-in-part of application No. 09/611,672, filed on Jul. 7, 2000.
(60) Provisional application No. 60/142,611, filed on Jul. 7, 1999.
(60) Provisional application No. 60/191,352, filed on Mar. 22, 2000.

(51) Int. Cl. G06F 7/00

(52) U.S. Cl. 707/10

(57) ABSTRACT

A system and method of managing virtual documents is described. These virtual documents have associated with them an attribute file having known header and field information. By using the attribute file information, a network-connected computer can categorize and store virtual documents in a database corresponding to a particular user of the system. According to one aspect, the system is designed so that it can interface with an interactive television computer system so that a user can select virtual documents that he wishes to retain while viewing a television program. The selected virtual documents are then categorized and stored in the database corresponding to the user. According to another aspect, virtual documents can be downloaded from network-connected computer to a user's computer and then transferred to a smart card device. Specifically, a merchant coupon may be downloaded to the smart card device so that it may be redeemed at a merchant's store.

### RELATED APPLICATIONS

This application claims priority to and is a continuation-in-part application of U.S. patent application Ser. No. 09/611,672, which has a filing date of Jul. 7, 2000 and which claims priority to the following two provisional patent applications:

| Ser. No. | Filing Date | Inventor |
|---|---|---|
| 60/142,611 | July 7, 1999 | Jeffrey W. Mankoff |
| 60/191,352 | March 22, 2000 | Jeffrey W. Mankoff |

The above applications are hereby incorporated by reference into this application. This application is further related to commonly owned U.S. patent application Ser. No. 09/309,989, which has a filing date of May 11, 1999, which is also hereby incorporated by reference herein.

### TECHNICAL BACKGROUND

A typical kitchen drawer might include, for example, merchant coupons, product warranties, sales receipts, product instructions, service instructions, rebates, gift certificates, product registration cards, event tickets, credit card statements, bank statements, and recipes. Collectively, we can refer to a general class of these types of documents as “retail collateral.” Paper documents are cumbersome and hard to organize.

Increasingly, retail collateral documents are sent to users electronically. Like paper documents, organizing virtual documents is cumbersome and hard to organize, as evidenced by most users e-mail inbox. Today's electronic organizers and contact managers are most-commonly associated with the individual user, and are maintained at the user's Personal Computer (“PC”), Personal Digital Assistant (“PDA”), or at the user's workplace on the Local Application Server (“LAS”). These organizers and contact managers are for managing the users' schedule, electronic-mail messages, and database of professional and personal contacts. schedule, electronic-mail messages, and database of professional and personal contacts. Although a user can manually set up folders in which to transfer e-mail messages from the inbox, given the volumes of messages a typical user receives between commercial and personal e-mails, the typical user's inbox becomes much like the cluttered kitchen drawer. Accordingly, these organizers and contact managers are not well suited to maintaining retail collateral documents of the type listed above, because such important documents will typically become lost in the “fog” of the cluttered inbox.

### BRIEF SUMMARY

Described is a system and method for distributing, collecting, and organizing Virtual Retail Collateral Documents (“VRCDs”), including virtual documents like merchant coupons, product warranties, sales confirmations and receipts, product instructions, service instructions, rebates, gift certificates, product registration cards, event tickets, credit card statements, bank statements, internet sites user names and passwords, and recipes. These VRCDs may be delivered to an Internet user or other network user via e-mail, banner ads, interactive television, or via digital phones, or other digital method, thus further adding to the organizational challenge for the consumer.

The application described below addresses these challenges through a web-based, electronic document management system that organizes and integrates VRCDs on an Internet-connected computer. As discussed below, this web-based electronic document management system can be accessed via handheld/PDA device or a personal computer-like appliance. Preferably, the system and method described below organizes the VRCDs alongside the consumer's personal information and integrates the VRCDs with that personal information.

The application described here addresses the converging needs of consumers, Internet-connected merchants, and content providers (e.g. Yahoo, Lycos and other portals). Consumers like discounts and coupons, organization, convenience, and ease of use, but need a tool to organize, archive and consolidate VRCDs; advertisers need to personalize and target their messages in order to get their message through to information-overloaded consumers; content providers need to enhance “stickiness” to maximize revenues from the sale of their mailing lists and banner ads. The described system and method addresses the needs of these disparate groups. In particular, the described system and method gets, facilitates and enables the advertiser/merchant's message to get through to the consumer, by automatically organizing the VRCDs for the consumer for later convenient and easy access by the user.

Preferably, the integrated, Internet- or Web-based organizer will become an all-important homepage for the consumer/user when connecting to the Internet, interactive television, mobile phones or other modern networks. This integrated homepage, comprising both virtual documents and the user's personal data, will serve as the user's integrated Personal Information Manager (“i-PIM”) containing all the user's personal data, integrated with the VRCDs. The i-PIM will preferably be capable of synchronization with or direct access by users' mobile devices, such as PDAs and cell phones. Preferably, the system and method will also be integrated with the user/consumer's calendaring system, so that the user/consumer will be able to reference in one place his contacts and calendar as well as receipts, instructions, bank and credit card statements and anything else the consumer might want to organize.

The process preferably begins with the user receiving a VRCD with an organizing button (henceforth VRC organizing button) in the form of an e-mail or by clicking a VRCD containing a VRC organizing button enabled banner ad for the first time. This will prompt the user to register with an entity that will maintain or host the web-based VRCD organizer. In an alternative embodiment, registration is automatically performed based upon the user's selection of the VRC organizing button. At an Internet-computer, the host will preferably establish an individual database. The individual database or user database will preferably be a record within a larger database. The user database, and preferably the other records within the larger database, will each contain a number of categories within which to store information from the VRCDs requested by the consumer/user. It is also possible that the consumer/user may not specifically request the VRCDs be sent to the VRCD database host, but alternatively such VRCDs may be automatically selected for the user based on a user-established profile.

To facilitate the categorization and storage of VRCD information, attribute files are preferably associated with each of such VRCDs. These attribute files would preferably have defined fields and header information which would be provided to a merchant or service provider, for example, who would attach or associate the attribute file with the VRCD sent to the user or to the VRCD database host on the user's behalf. The merchant or service provider would preferably attach the attribute file to the VRCD, which would then be sent to the user or the users' individual database at the entity's website, through one of many different channels. Once these VRCDs are sent for storage to the host of the VRCD web-based organizer, the host will then know from the attribute file how to categorize or classify the information from that VRCD. In other words, the merchant or service provider provides the VRCD along with an attribute file, which allows the host of the web-based organizer to automatically categorize a user's Information contained within the attribute file which might include a merchant ID, merchant class, web site URL, merchant address, map, and e-mail information. More preferably, a merchant ID and promotion ID might be the only information contained in the attribute file, and the other merchant characteristics would preferably be stored and associated with that vendor at the PDRC VRCD database web host.

Although the user database at the Internet-connected host computer would preferably be associated with an individual Internet user/consumer, such databases could be assigned alternatively to groups of affiliated user/consumers, such as businesses or charitable or civic organizations.

First-time registration could be direct with the host or administrator of the VRCD database computer, or it could be through an affiliated Internet-connected merchant or other site. The user/consumer would preferably use an existing e-mail address or be assigned a new e-mail address that might be used exclusively for receipt and request of commercial, e.g., bulk or targeted, virtual documents. Typically, users have more than one e-mail address, and consequently users receive VRCDs via different e-mail addresses. The user can provide these different e-mail addresses at registration to the VRCD entity, so that when the VRCD is forwarded from any of the user's e-mail addresses to the VRDC entity, the system can recognize it and organize them with the single user. Often times, users set up multiple e-mail addresses in order to receive multiple coupons, which typically are offered only to a single e-mail address. This embodied system has the benefit of recognizing that more than one offer has entered the VRCD organizer, and block duplication of offers in the same VRCD organizer per user.

In the instance of commercial solicitations through bulk or targeted e-mails containing embedded VRCDs, the VRCD database host or administrator would preferably provide a merchant, who has received opt-in authorization from the consumer, proprietary header and field format information for the attribute file to be associated with the VRCD; the VRCD would then be embedded in the e-mail or banner ad solicitation. The embedded VRCD preferably contains a VRCD organizer button, which the consumer would click, and the VRCD would be transmitted through the network to the VRCD database host. The information from the VRCD would then be placed in the appropriate portion of the user database based on the information in the VRCD's affiliated attribute file. Once information from such VRCDs are in the user database, the user/consumer who is the “owner” of that database can conveniently access that information at any time. By this technique, the advertiser can distribute a coupon VRCD via mass e-mail or banner ad.

Depending on how the system is configured, VRCDs can be sent directly to the VRCD database host for filtration and storage in the user database, or they can be sent to the user for discretionary forwarding to the VRCD database host. In either case, upon reaching the VRCD database, the VRCD is sorted by category, and information from the VRCD is stored as a new record with defined portions of the VRCD being stripped from the overall file and placed in the corresponding record fields of the user database. The fields culled from the VRCD and placed in the database preferably include such things as hyperlinks for the merchant home site, in the instance of promotional offers, hyperlinks to the merchant offer page, offer details, merchant addresses and phone numbers, offer details, pertinent dates, and the like.

If the VRCD is associated with a banner ad, the consumer would click the VRCD organizer button in the coupon banner ad, and the VRCD would be transmitted through the network and placed in the appropriate portion of the user database. Once information from such VRCDs are in the user database, the user/consumer who is the “owner” of that database can then conveniently access that information at any time. Banner ad click-through rates have declined substantially. The rates that destination sites can charge have declined as a result. Moreover, banner ads often take the user away from the destination site to the advertiser, reducing stickiness. For the consumer, it may not be convenient to click the banner ad to click through and claim the offer, even though he wants it. By providing a system which provides convenience for the user to click the banner ad and claim the offer and organize the offer in his personal VRCD organizer for later redemption with the merchant, while staying at the destination site, the three parties, consumer, merchant, and destination site benefit. The user can claim the offer at a later convenient time; the merchant can make another sale, and the destination site can charge more for its banner ad space.

The described technology facilitates more than traditional e-commerce applications. For instance the described system and method would allow manufacturers or service providers to provide click-links for virtual-document product or service information or virtual-document warranties at their homepages. For example, a user might purchase a portable music player and register with the manufacturer. The manufacturer would then send via e-mail to the user a “thank you” for registering in the form of the VRCD system, which could then be organized in the user's VRCD web-based organizer under instructions/warranties, and provide in list format a summary of the name of the manufacturer with hyperlink, a hyperlink to particular product instructions, a hyperlink to product warranty information at and go to the manufacturer's website to obtain virtual-document product instructions and a virtual-document product warranty, an expiration date of product warranty, a customer care telephone number, and an e-mail contact. The virtual-document instructions and warranty could then be viewed within the user's i-PIM. In accordance with the previously described procedures, the user may choose to have this information stored in his database. This may be accomplished by clicking on a VRC organizing button that appears within the VRCD.

In some instances, one of the fields of the received VRCD may be a hyperlink for a merchant or service provider with whom the user has an account. In this instance, it may also be preferable to include fields for the user and password for accessing the particular hyperlinked site. Using this approach, it may be possible to directly access the merchant or service provider website from the user's personal VRCD database screen by transmitting the username and password automatically to the hyperlinked site when the user clicks on that hyperlink or otherwise attempts to reach that website from within his personal VRCD database screen.

The VRCD organizer can be applied to any medium for delivery of electronic documents. For example, interactive TV and web-enabled phones are channels by which these virtual documents may be delivered to consumers. Specifically, if an ad for a clothing store is on during an interactive television program, the viewer may click a “save this offer” button on his remote control. When this is done, the interactive television receiver will forward the viewer's e-mail address (or other indicia) to the host computer indicating that the view is interested in a particular product or offer. At this point, the product/offer would be added to the viewer's I-pim and a notification would be sent to the viewer's e-mail address.

The “i-PIM” VRCD organizer can be accessed through a wide variety of channels such as the Internet, interactive TV, web-enabled phones, and web-enabled PDAs. Thus, with portable handheld devices, the consumer's VRCD can be accessed anytime, anywhere. If the consumer needs to check the status of his current promotional offers or instructions, he need only use his web-enabled PDA to access this VRCD.

The above summary has outlined the embodiments described in this application, but this description is only to be used in the context of the entire specification to illustrate some of the major features of these embodiments. Accordingly, other features and a fuller understanding of these embodiments may be had by referring to the entire specification. None of these embodiments are limiting of the scope of the invention, which must be determined by the claims set forth in the claims section.

### BRIEF DESCRIPTION OF THE DRAWINGS

FIG. 1 is a block diagram of the a network upon which the embodiments of the Virtual Retail Collateral Document (“VRCD”) organizer can be implemented;

FIG. 2 is a block diagram of an embodiment of the host environment for the VRCD organizer, for storing VRCDs in a user's individual database;

FIG. 3 is a flow diagram for a method by which VRCDs can be organized and distributed;

FIG. 4 is a data structure diagram of a VRCD and its affiliated attribute file;

FIG. 5 is a diagram of the “Coupon: Restaurant” portion of the user's individual database as it might appear on the user's client display screen;

FIG. 6 is a diagram of the “Coupon: Grocery” portion of the user database as it might appear on the user's client display screen;

FIG. 7 is a diagram of the “Instructions/Warranties” portion of the user's individual database as it might appear on the user's client display screen;

FIG. 8 is a diagram of the “Rebates” portion of the user's individual database as it might appear on the user's client display screen;

FIG. 9 is a diagram of the “Bills” portion of the user's individual database as it might appear on the user's client display screen;

FIG. 10 is a diagram of the “Itineraries” portion of the user's individual database as it might appear on the user's client display screen;

FIG. 11 is a diagram of the “Contacts” portion of the user's individual database as it might appear on the user's client display screen; and

FIG. 12 is a diagram of the “Calendar” portion of the user's individual database as it might appear on the user's client display screen.

FIG. 13 is a block diagram of one aspect of the invention that utilizes smart cards.

FIG. 14 is a plan view of one embodiment of a smart card suitable for use with the disclosed invention.

FIG. 15 is a side-profile view of one embodiment of a smart card suitable for use with the disclosed invention.

FIG. 16 is a diagram of the contacts on a smart card suitable for use with the disclosed invention.

FIG. 17 is a block diagram depicting components of a smart card suitable for use with the disclosed invention.

### DETAILED DESCRIPTION OF THE EMBODIMENTS

### System Architecture

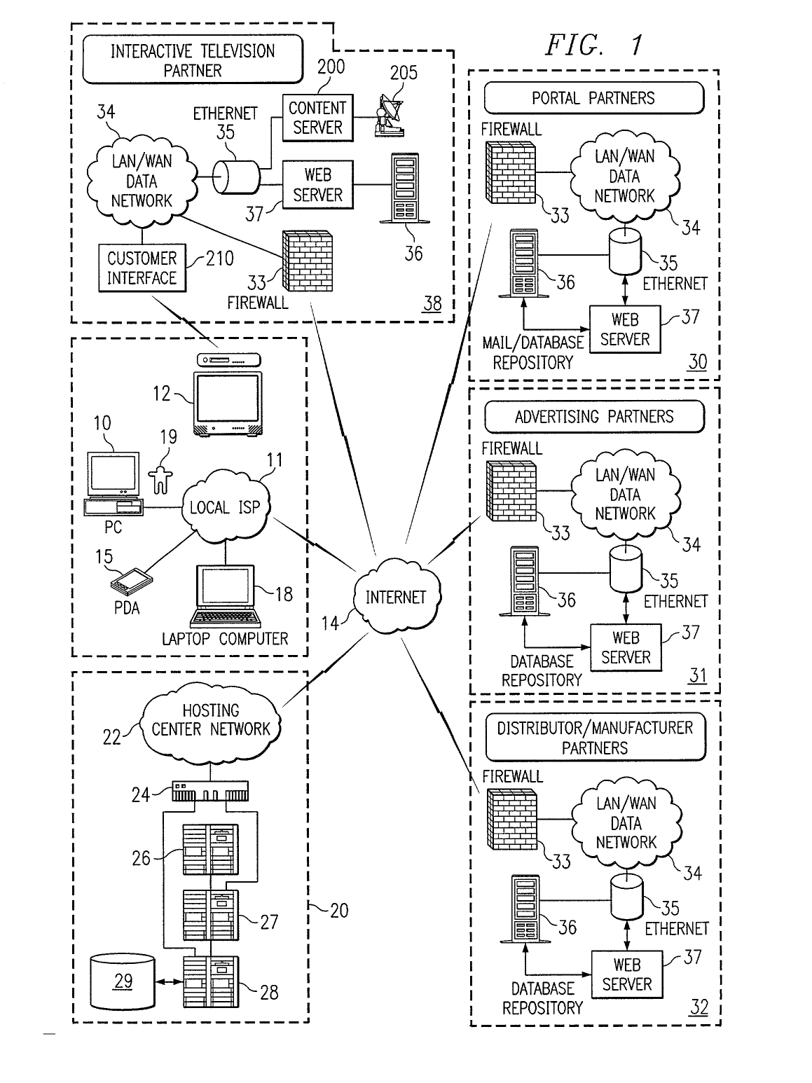

FIG. 1 illustrates an Internet client-server system upon which the Virtual Retail Collateral Document (VRCD) organizer system and method can be implemented. In this block diagram, a client machine 10 is provided, which is preferably a Personal Computer (PC), but could also be a Personal Digital Assistant (PDA) 15, a laptop computer 18, or an interactive television receiver 12. An Internet browser application is preferably provided on the client machine 10, 12, 15, or 18. On the interactive television receiver 12, a proprietary application may also be used to access Internet-based content. The client machine 10, operated by user 19, then connects to the VRCD database host 20 through the network 14, preferably the Internet, typically through a local Internet Service Provider (ISP) 11. The user 19 may also access the VRCD database host 20 by using the interface for the interactive television receiver 12.

Within the VRCD database host 20, a local network 22 is provided along with a router 24. The Internet browser application in the client typically communicates with the VRCD database host 20 through a web server 26, which may be a separate computer within the database host 20, or may be an application running within a single computer comprising the database host 20. In the applications described below, the VRCD database host 20 preferably comprises a web server and its associated software components, including: the web-server operating system (e.g., Windows, Linux, AIX); an IIS server used to deliver HTML and ASP content and applications to the client web browser; a site server used primarily to deliver personalized web content to users, an index server for indexing web content and providing users with website-specific search and query results; web publishing server extensions for deploying and publishing web content and applications from the development and test environments; site monitoring and management tools for monitoring traffic and content on the website; and components for XML parsing. Also included in the VRCD database-hosting environment would be an application server 27, a database server 28, and a database 29 associated with the database server. The application server 27 would preferably provide application component communication either internally or externally to partner-based applications and or FTP transfer functionality.

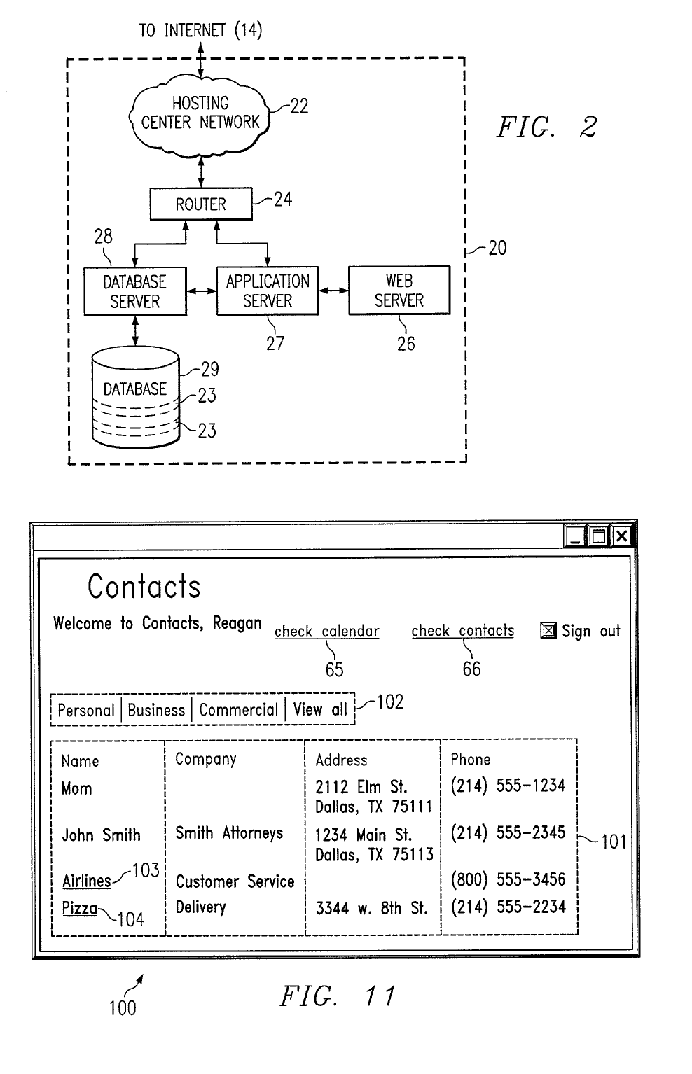

As shown in FIG. 1 and in greater detail in FIG. 2, the database server 28 would preferably store and retrieve data elements to and from its associated database 29, including the user databases 23 which are provided within the overall database 29.

Referring again to FIG. 1, also connected to the network 14 are several exemplary partner sites for the Virtual Retail Collateral Document (VRDC) host administrator or server. These exemplary partner sites include a portal partner site 30, an advertising partner site 31, a distributor/manufacturer partner site 32 and an interactive television partner site 38. These partner sites would in general comprise similar functional blocks, which would include a firewall 33, a LAN/WAN data network 34, an Ethernet 35, a database repository 36, and their own web servers 37. The interactive television partner site 38 would additionally comprise a content server 200, a content network interface 205, and a customer interface 210 for communication with a specific user 19. With these components, the partners would preferably have their own Internet connectivity accessible to at least the VRCD database host 20 and preferably also to the users 19.

A portal partner 30 would preferably be a common user destination for searching, directories, and other information. Users 19 will preferably enter the portal, and in embodiments described herein would find commercial content of interest to the user. This content might be available to the user through virtual documents, such as merchant coupons, product warranties, sales receipts, product instructions, service instructions, rebates, gift certificates, product registration cards, event tickets, credit card statements, bank statements, and recipes. These virtual documents are referred to generically in this application as VRCDs, and the VRCD database host 20 will organize these VRCDs for the user according to methods described below. In some instances, the user 19 will access the database host 20 directly through a connection between the user's client computer 10, 15, 18 and the host's web server 26. But given that many portals maintain personal information for users of their sites, it may be preferable that the VRCD database host 20 operate as an application within the portal site 30, such that the VRCDs stored for the user might actually appear to be stored within a portal application itself.

The advertising partners' sites 31 might provide banner ads to many different destinations on the Internet or other electronic network. Clickable VRCDs might be embedded in these banner ads the VRCDs, such that the VRCDs would preferably be delivered to the VRCD database host 20 in response to a user 19 clicking on one of these banner ads. The VRCD would preferably be provided to the VRCD database host 20 through the electronic network 14 and would be placed in the appropriate portion of the user database 23 according to an attribute file associated with the VRCD.

Still referring to advertising partner sites 31, in the instance of commercial solicitations through bulk or targeted e-mails, the VRCD database host or administrator 20 would preferably provide the advertiser site 31, who has received opt-in authorization from the consumer 19 or fits within the consumer's profile, a proprietary identification code to be embedded in the e-mail solicitation. The advertiser can then send the standard coupon via mass e-mail or banner ad. Depending on how the system is configured, the VRCD could be sent directly to the VRCD database host 20 for filtration and storage in the user database 23, or it could be sent to the user 19 for discretionary forwarding to the VRCD database host 20.

The approach with the merchant/distributor site can follow any of the approaches described above with respect to the portal partner site 30 and the advertiser partner site 31. In fact, any of the above approaches could be adapted for any type of web-connected partner according to that partner's unique needs. Applications other than traditional e-commerce applications can be facilitated by this system and method. For example, manufacturers/distributors/service providers could provide click-links for virtual-document product or service information or virtual-document warranties at their homepages 32. These virtual documents such as product or service information or warranties could be transmitted to the user's i-PIM at the database host 20, where they could be viewed at the user's convenience. The approach with the interactive television site can follow any of the approaches described above with respect to the portal partner site 30, the advertiser partner site 31, and the merchant distributor site 32. In fact, any of the above approaches could be adapted for any type of web-connected partner according to that partner's unique needs. In one embodiment, the interactive television partner 38 will provide content to a user in the following manner. First, content would be received at a content network interface 205 from a variety of sources, including satellite, radio transmission, cable broadcast, and the Internet. Upon receiving the content, it would be processed by a content server 200 to descramble and/or demodulate the signal and put it into a format that is suitable for retransmission. The content would then be transmitted through Ethernet 35 to the LAN/WAN 34 where it would be forwarded to the customer interface 210. At the customer interface 210, the content would be combined with VRCD information and would then be transmitted to the user 19 through the interactive television receiver 12. The VRCD information can be received at the customer interface in a variety of ways including from the database repository 36 through the web server 37, or from the VRCD database host 20 through the Internet 14. Upon receiving the content and VRCD information at the interactive television receiver 12, a user 19 would have the option to browse through the appropriate information to find the content and VRCD information most relevant to his interests. This browsing can be accomplished in a variety of ways, such as through a traditional Internet browser program, a selectable remote control device designed to work with the interactive television receiver 12, or through the proprietary browsing device. Upon finding content/VRCD data that is of interest to him, the user can select the VRCD for storage in either the database repository 36, or at the database host 20. As described above, the VRCD information may be stored in an appropriate portion of the database (36 or 29) according to an attribute file associated with the VRCD.

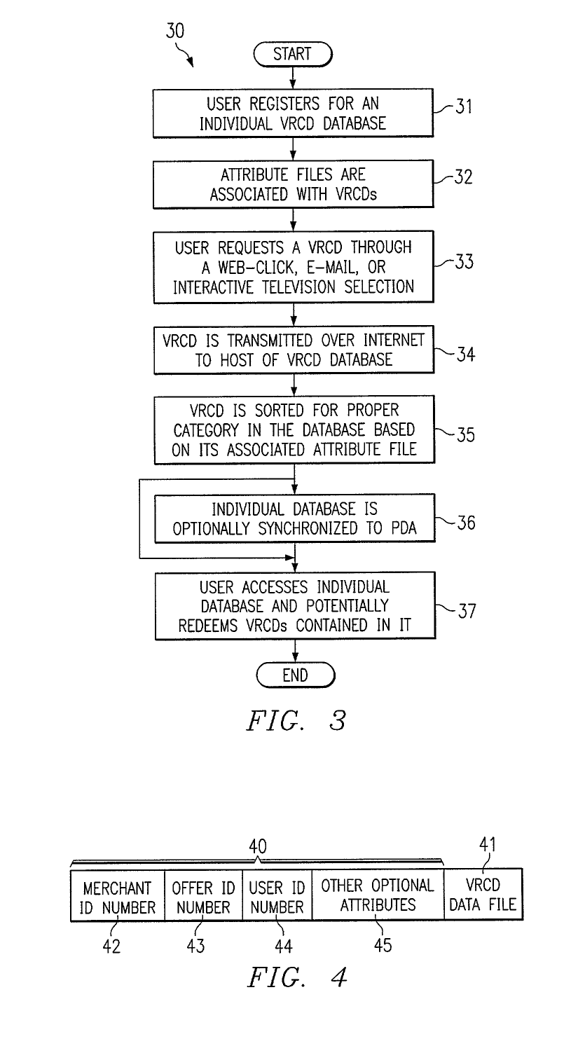

In any of the above instances, upon reaching the VRCD database 29, the various field information will be stripped from the VRCD and e-mail message will be stripped of its e-mail appearance, sorted by category according to the attributes stored in the attribute file 40 (not shown, see FIG. 4) associated with the VRCD 41 (not shown, see FIG. 4), and automatically placed in the appropriate portion of the user database 23.

### VRCD Organization Method

This method is described in greater detail in the flowchart of FIG. 3. As described in this figure, with reference still to FIGS. 1-2, the process 30 preferably begins with the user registering 31 with an entity that will maintain or host the web-based VRCD organizer. First-time registration could be direct with the host 20 of the VRCD database computer, or it could be through an affiliated Internet-connected merchant or other site 30, 31, 32, or 38.

The user/consumer 19 would preferably use an existing e-mail address or be assigned a new e-mail address that might be used exclusively for receipt and request of commercial, e.g., bulk or targeted, e-mails. Because users often have more than one e-mail address, in the application described here, users often would receive VRCDs via their different e-mail addresses. The user can provide these different e-mail addresses at registration to the VRCD entity, so that when the VRCD is forwarded from any of the user's e-mail addresses to the VRCD entity, the system can recognize it and organize them with the single user. Often times, users set up multiple e-mail addresses in order to receive multiple coupons, which typically are offered only to a single e-mail address. This embodied system has the benefit of recognizing that more than one offer has entered the VRCD organizer, and can thus block duplication of offers in the same VRCD organizer per user.

At functional block 32, the VRCD database host 20 through the database server 28 preferably establishes a user database 23 within the database 29. The user database 23 will preferably comprise a record within a larger database 29. The user database 23, and preferably the other records within the larger database, will each contain a number of categories within which VRCDs requested by the consumer/user can be stored. It is also possible that the consumer/user may not specifically request the VRCDs to be stored within the user database 23, but alternatively such VRCDs may be selected based on a profile associated with that user/consumer 19.

Still referring to FIG. 3 and specifically to block 32, to facilitate the filtering and storage of VRCDs, attribute files are preferable associated with each of such VRCDs. A data structure of how these files could be associated and structured is illustrated in FIG. 4; this data structure is described below. The attribute files (not shown, see FIG. 4), for example, would be provided to the merchant partner 30, 31, 32, 38, who would attach or associate the attribute file with the e-mail sent to the user.

At block 33, a user can request that a VRCD be sent to the host 20 by responding to an e-mail solicitation or clicking on a banner ad or other clickable graphic. If responding to an e-mail solicitation, there would preferably already be an attribute file, which would be attached to the user's e-mail response. The e-mail response could be sent directly to the host 20 or through one of the merchant sites 30, 31, 32, or 38, which could log the “hit” and forward the information on to the host 20. If the user responds by clicking a link, the VRCD would preferably be sent (at block 34) with its affiliated attribute file directly from the applicable merchant site to the host 20.

According to block 35, the host 20 will sort the VRCD according to information in the attribute file and store this information in the appropriate user database 23 of the database 29 according to the filtering and classification by the attribute file information. This process will also update the user's integrated-PIM or “i-PIM”, which is stored in the user database. The i-PIM is then available for user access, and the user can optionally synchronize a PDA at block 36 to the PIM or interact directly with the web server 26 of the host 20.

As shown in FIG. 4, information contained within the attribute file 40, which is associated with the VRCD data file 41, might include a merchant ID 42, offer or promotion ID 43, user ID 44, or other attributes 45. Other attributes might include merchant class, web site URL, merchant address, map, and e-mail information, but preferably this additional information could be associated with the particular merchant ID at the host 20, and be integrated into to the i-PIM there.

Again, preferably the VRCDs will include merchant coupons, product warranties, sales receipts, product instructions, service instructions, rebates, gift certificates, product registration cards, event tickets, credit card statements, bank statements, and recipes, and preferably the user database at the Internet-connected host computer would preferably be associated with an individual internet user/consumer, although databases could be assigned alternatively to groups of affiliated user/consumers such as businesses or charitable or civic organizations.

### Screen Displays for VRCD Database

Referring now to FIG. 5, virtual coupons or “voupons” are particularly well-suited to organization and collection according to the embodiments described above. As shown in the figure, which is a diagram of the “coupon” portion of the user's individual database 23 as it might appear on the display screen of the user's client PC 10 or the interactive television receiver 12. This particular screen 50 might be accessed directly from the database host web server 26, or it might be transparently integrated within another entity's web site, such as a portal web site 30 or from an interactive television partner's database 36.

In one preferred approach, the user 19 might have saved the “Pizza” voupon coupon in response to an e-mail solicitation from the pizza restaurant. Under this approach, the pizza restaurant would have e-mailed the coupon with a promotional ID or coupon ID 43 to the user 19-the coupon ID 43 would preferably have been provided to the merchant by the data base host 20. The user's client could be set up either to automatically register this offer at the individual database 23 or to do so only if Joe “accepts” the offer. Under this application, since the user's individual database 23 is preferably stored on another web-connected site 20, a VCRD 41 is transmitted to the host 20 with an affiliated attribute file 40. If the promotional ID or coupon ID 43 is unique, this would be the only information that would need to be transmitted to the host 20. Alternatively, other attribute information could also be provided to the host 20 such as specific information about the merchant. Preferably, an attribute that uniquely identifies the user is also placed within the attribute file 40 so that the VRCD can be assigned to the appropriate individual user's database 23.

Rather than immediately transferring this information to the host 20, the VRCD may be stored in an organizer associated with the client, and the web-based i-PIN at the host 20 can be updated to include this information upon the next synchronization between the client device and the web host 20.

Still referring to FIG. 5, in this application, there is a proprietary code comprising at least the promotional ID or coupon ID embedded in the mass e-mail to the user that allows the system described herein to translate the e-mail and automatically store it in the “Coupons: Restaurants” section of the user database 23. Upon closer examination of the screen 50 of FIG. 5, it can be seen that the highlighted tab at the top of the screen is the “Coupons” tab 52. Although not showing it in database format, the data within box 51 of FIG. 5 illustrates the data which would be stored in the “Coupons: Restaurants” section of the user database 23.

Other tabs seen at the top of FIG. 5 include an “Instructions/Warranties” tab 53, a “Rebates” tab 54, a “Bills” tab 55, and an “Itineraries” tab 56. This list of categories/tabs is not exhaustive, nor even necessarily fixed. In other words, the database server 28 working with the applications server 26 would preferably operate to define new categories as such new categories arose during use of the system and method described herein.

Convenient information shown on the screen 50, includes the name of the restaurant 57, the offer details 58, the offer expiration date 59, the restaurant telephone no. 60, and the coupon code 61. The coupon code shown here could be the same as or derived from the coupon ID or promotion ID 43 that was associated with the VRCD originally. As previously mentioned, this might have been the only information transmitted to the host 20 by the remote site 30, 31, 32, 38 or the client 10, and the host 20 might have had a database of coupon codes that would tell the host 20 the restaurateur 57, offer details 58, expiration date 59, and restaurant telephone 60.

Also seen on FIG. 5 is an exemplary banner ad 62. The pizza restaurant voupon could clip through a clickable-link or button 63 as shown in the ad. Although in this instance, the banner ad is shown as a banner ad right on the hosted web site, this clickable banner ad embodying a voupon could be on any web site so long as the merchant or advertiser were a partner of the VRCD data base hosting company 20. The voupon will be automatically organized and stored in the user database 23 by the database server 28, preferably as described in the method described with respect to FIG. 3 and the accompanying text.

A set of coupon sub-classifications is accessible by the clickable links 64 shown above the restaurant offers of FIG. 5. Just as the broader classes of VRCDs (coupons, rebates, bills, etc.) are not exhaustive, neither are these narrower categories. Shown in this example within clickable links 64 are “Restaurants, Music, Fashion, Grocery, and View All.” Also shown on FIG. 5 are clickable links 65, 66 for personal information databases (calendar 65 and contacts 66). It is the integration of these personal information databases with the VRCD information that comprises the web-based VRCD organizer or i-PIM described in this application.

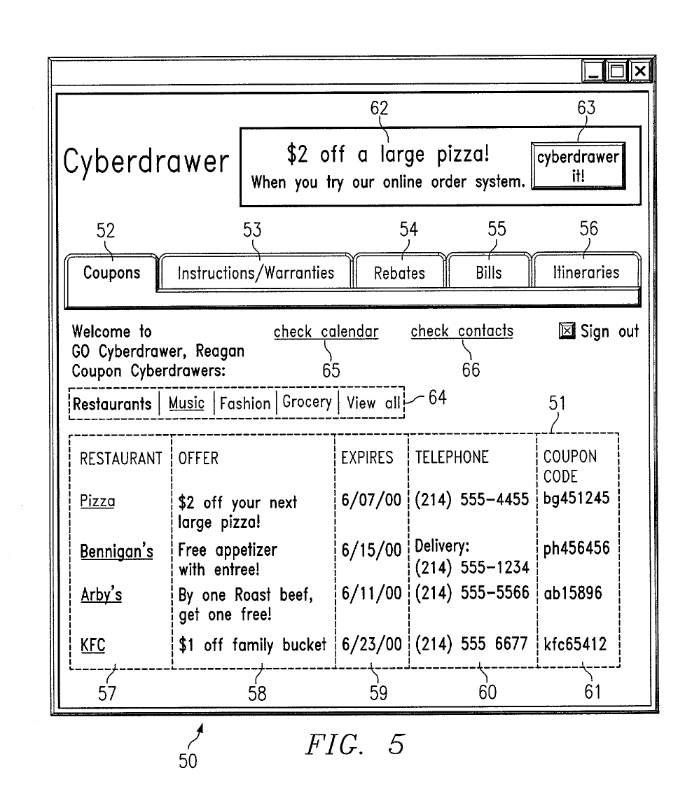

FIG. 6 is a screen display for the “Coupons: Groceries” category of the user's web-based i-PIM. Shown in this screen are the user's grocery manufacturer and grocery store coupons. Preferably, as shown in this figure, the consumer can also integrate his coupon preference shopping list 67 with an online grocer. The online grocer can be selected using a drop-down list 68 or other known web design technique for providing an item “selector.” The consumer selects his online grocer using the drop-down list 68, and the VRCD database host then seamlessly connects the user to an affiliated online grocer to retrieve the consumer's previous shopping list from the online grocer. If the user is already at an affiliated online grocer website, that online grocer can preferably access the user's coupon preference grocery list from the VRCD database host.

When the user/customer decides to grocery shop online, he will preferably connect to the affiliated online grocer via pull-down list 68. The affiliated online grocer will then preferably have access to the user's individual VRCD database 23, enabling the user while at the online grocer's site to pull up his coupon list 51 and his grocery list 67, and proceed with his shopping. After the consumer completes his shopping, the i-PIM organizer automatically matches coupons previously clipped and collected on the user database 23 with items selected for purchase from the grocery list 67, by brand or price preference. If the user has set his shopping list coupon preference to purchase the bread at the lowest price and without brand preference, the i-PIM organizer will automatically match the coupons with the bread brands and choose the lowest price product (accounting for coupons) utilizing the server applications operating on a server within the database host. If he selected Pepsi to purchase online, and he has a brand coupon preference for soft drink, the VRCD database organizer will search only for Pepsi coupons, which it will match, if available, to the item Pepsi-brand item purchased.

What the consumer sees next are the items chosen in the grocery list 67 chosen according to the consumers' preferences. The consumer can accept all the items chosen, or individually change items and search for other coupons in the coupon organizer if he does not like the particular brand chosen. Once he has completed this step, he will then submit his purchase request. The online grocer will then contact the user database 23 to redeem the matching coupons that are stored within the user's individual database.

It is also possible to set up the user's web-based i-PIM for automatic grocery shopping by configuring the i-PIM with the user's online grocer login name and password. By doing this, the i-PIM can accept the user's shopping list 67, automatically login to the online grocer's website according to the pull-down menu selection 68, gather or select the items for purchase based on the user's brand preferences, item prices, and available coupons, and present these choices to the user at the i-PIM “Coupons: Grocery” screen described above. The user can then modify the choices and approve the selections, and the i-PIM can complete the purchase with the on-line grocer based on the user's final selection.

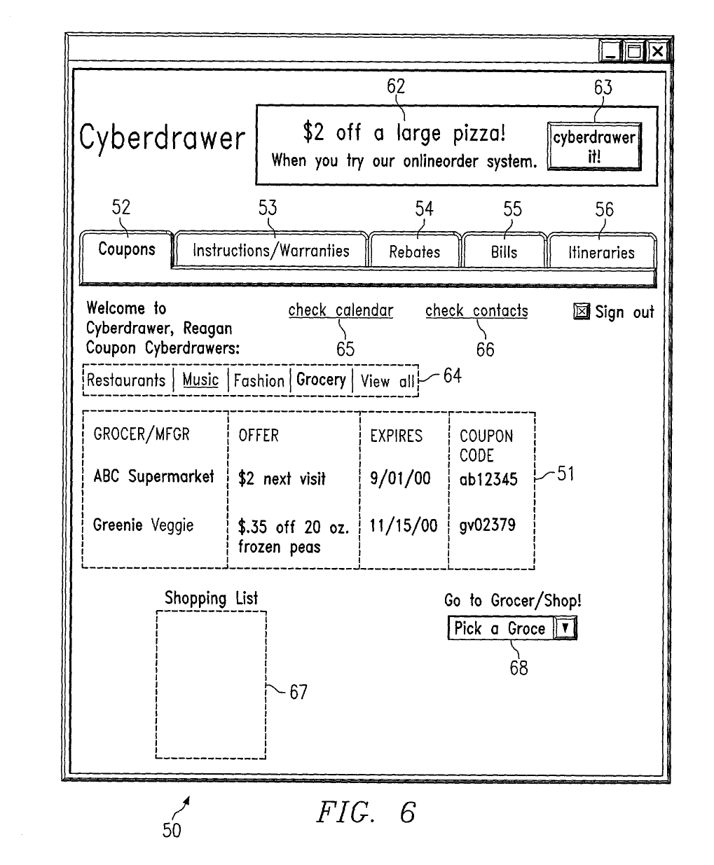

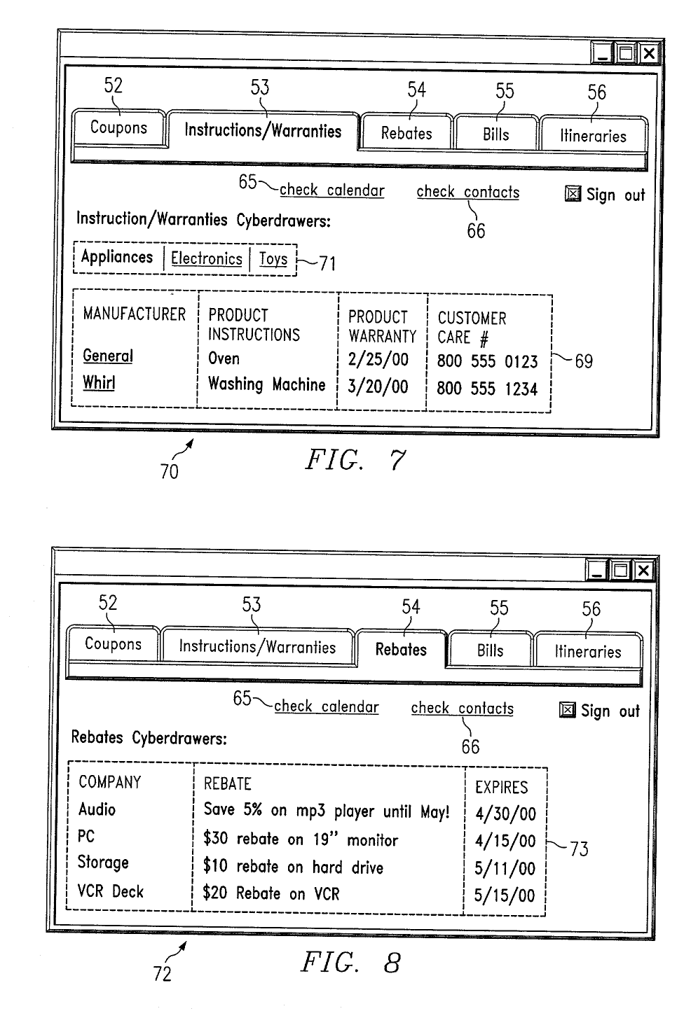

FIG. 7 shows a screen 70 that is similar to the one provided for “Coupons: Restaurants” 50. The tabs 52, 53, 54, 55, 56 and clickable links 65, 66 shown in FIG. 7 that have the same reference numbers in FIGS. 5-6 perform the same functions as in those figures, and they will continue to perform the same functions in the subsequently-described figures. The screen 70 contains information relative to instructions and warranties that is generally analogous to the information of table 51 in the screen 50 of FIG. 5. As shown in the clickable links 71, a non-exhaustive list of product instructions/warranties in this context would include “Appliances, Electronics, and Toys.” Given that there is no unique coupon ID associated with these rebates, this poses questions as to how the information for the VRCD reaches the user database 23. One approach would be to assign a unique number to each warranty or product instruction document and then as with the unique coupon or promotional ID 43 (see FIG. 4), it would only be necessary to transmit that information to the host 20 to identify the full VRCD. Alternatively, all relevant details for identifying the product warranty or information sheet could be transmitted to the host 20 from the partner web site. One detail that would preferably be included would be a web site where the actual text of the document is stored; alternatively, the actual text of the document could be stored in the user database 23.

FIG. 8 is the screen shot 72 for the “Rebates” category. Although no subcategories of rebates are shown in this screen shot, the category could be divided in to subcategories according to the type of merchant or service provider the rebates relate to. The database information shown here includes the company, rebate details, and rebate expiration date. As with the product warranties and product information, there is no coupon or promotion ID which uniquely identified the elements shown here. As before, there could be assigned a hidden such ID which would be transmitted to the host 20 to specify the information to be stored, or the entire set of relevant information could be submitted each time.

FIG. 9 provides the screen shot 80 for the “Bills” category. The merchant and statement details are provided in the table 81 that will be stored in the user database 23. Preferably, the database 23 also stores the actual content of the bills or merchant statements. In this manner, the user database will act as a sort of “shoebox” for archived bills, bank and credit card statements. Here again, the “Bills” category could be divided into subcategories accessible by a click link on the page.

Preferably in the record for each statement stored in the individual VRCD database 23 and displayed on the “Bills” screen 80, there would be provided an Internet hyperlink to the merchant, bank, or credit card company website. If the user's login name and password are provided to the i-PIM, the user will be able to click directly into their online account with the respective company or the i-PIM would be able to access the merchant website directly.

Another exemplary screen shot is provided in FIG. 10. This screen shot 90 is for the “Itineraries” category. Subcategories for travel and hotel itineraries are provided for this category with the clickable links 92 shown. The information that will be provided to the VRCD database host 20 will typically be provided in this section by VRCDs provided to the database host 20 by airlines, travel agents, and online travel planning websites. So that the VRCD database host 20 can properly recognize and parse incoming VRCDs from these sources, the VRCD administrator will provide header and field formats to these VRCD sources whereby the sources can conform their VRCDs to the expected format. In this manner, for instance, the VRCD database host 20 can recognize that an incoming file or message is a VRCD file compatible with the i-PIM. The database host will further be able to parse the fields from the incoming VRCD according to the predetermined formats, and will thus be able to store the pertinent field information in the user's individual database 23 according to the information provided by the airline, travel agency, or travel website VRCD data source.

Thus, for example, upon setting up a trip through an online reservation travel website, the online travel agent may send a confirmation e-mail to the user at his i-PIM, and to this confirmation e-mail there may be attached a VRCD from which the i-PIM can strip the relevant information such as flight numbers, departure and arrival times, confirmation numbers, and airline contact information. Similarly, the hotel contact information and address, and even a map, could be provided and stored at the user's individual database 23. This information would be automatically parsed and categorized in the appropriate subsection of the user's individual database 23.

FIG. 11 is an exemplary screen shot 100 of the contact manager of the user's 19 web-based integrated-PIM or i-PIM. “Personal,” “Business,” and “Commercial” subgroups are provided in the contact manager by clickable links 102. The table 101 shows an exemplary set of information that is associated with each of the entries of the contact manager. A feature that is illustrated by this embodiment is the feature of the VRCDs in other categories also providing information that is useful for the i-PIM's contact manager and calendar. For example, there are entries 103, 104 in the table both for an airline and for a pizza delivery company. In one embodiment, these entries were completed when a VRCD for another category such as “Bills,” “Coupons,” or “Itineraries” had been received which also included contact information for the merchant or service provider associated with the bill, coupon or itinerary. For example, the entry 103 shown here for “Bills” may be automatically created with the receipt of a pizza coupon, and thereby a contact list entry is created having the address and phone number for the pizza delivery company. As another example, the entry 104 may be automatically created with the receipt of an itinerary VRCD. Integrated functions like this help the user to keep up with or manage his or her resources effectively.

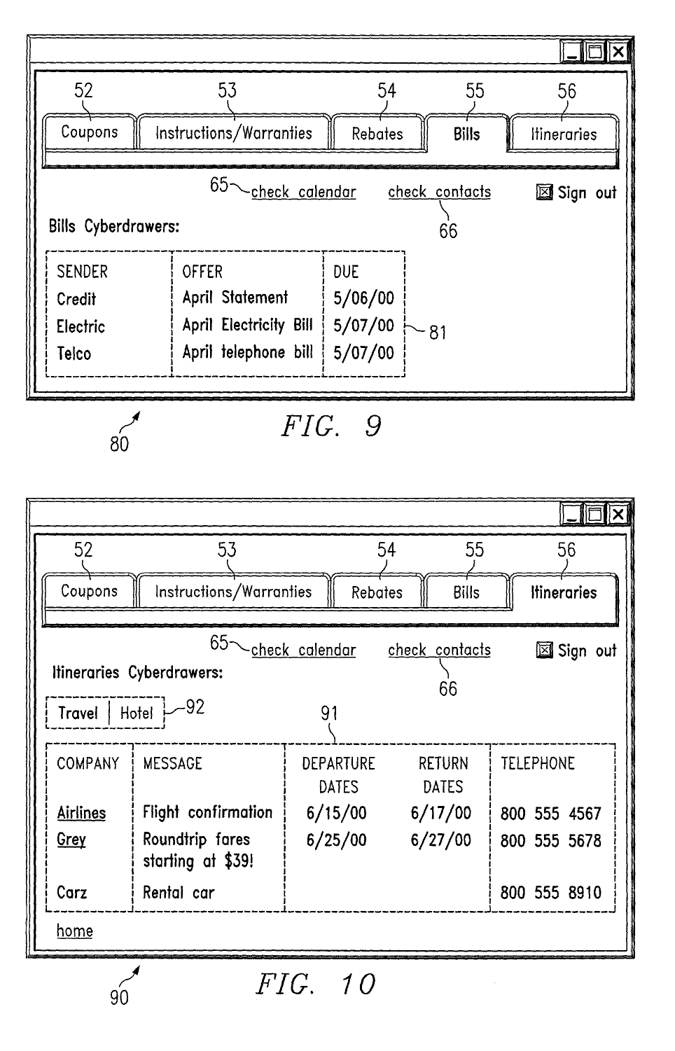

FIG. 12 similarly shows in a screen shot 110 the calendar function of the i-PIM. Here, along with the user's normal calendar, other calendar entries can be automatically generated by the receipt of VRCDs. This calendar can be provided at a website hosted by the VRCD host 20, and accordingly the user could go directly to that website to maintain his personal calendar. The software for the online calendar can be provided on the i-PIM website server, or it can be provided through a calendar-hosting service. Internet portals often act as calendar hosts, sometimes from their own sites directly and sometimes through a company that specializes in online calendar software development and hosting, such as eCal, Inc. Examples of the features that can be provided through these online calendar services are described in U.S. Pat. No. 5,960,406 for Scheduling System for Use Between Users on the Web, to Rasansky, et al.

Within the present application, it is disclosed that such online calendars can be automatically updated with important dates according to the VRCDs that have been received and categorized by the VRCD database host 20. For example, upon receipt of a coupon, the expiration date for the coupon can automatically be registered on the user's personal online calendar. Preferably, the user may set a certain threshold value of the coupon, $10 for instance, before the expiration date of that coupon is noted on the online calendar. Other types of received and categorized VRCDs often have important dates associated with them, which would preferably be automatically noted on the user's online calendar.

For instance, it may be useful to automatically update an online calendar with a maintenance schedule when certain types of product instruction VRCDs are received. Examples of such types of products might be battery replacement dates for smoke detectors and maintenance schedules for automobiles. By providing the header and field information for such instruction VRCDs to the product vendors, the VRCD database administrator can ensure that this information can be automatically parsed from the VRCDs and updated to the user's online calendars. Similarly, rebate expiration dates can be automatically culled from “Rebate” VRCDs and updated to the user's online calendars, and bill due dates can be extracted from “Bill” VRCDs and noted on the user's online calendars. In addition, flight arrival and departure information can be pulled from “Itinerary” VRCDs by providing specified VRCD header and field formats to the airlines, travel agents, and online travel planning sites.

In those instances where the user's online calendar is maintained elsewhere than the VRCD database host 20 (i.e., the online calendar access may be provided through a dropdown menu on the i-PIM calendar page 110), the VRCD organizer still provides for automatic updating of the user's calendar by receiving from the user the username and password by which to access the online calendar. With this usemame and password, the i-PIM organizer can be programmed, preferably through one of the servers resided in the VRCD database host 20, to access and update the user's online calendar.

FIG. 13 depicts another aspect of the invention whereby virtual coupons (“voupons”) may be downloaded to a user's PDA 15 or smartcard 1300. In FIG. 13, it can be seen that a voupon may be downloaded to a user's PC 10, PDA 15, or laptop computer 18 from the Internet 14 through the user's local ISP 11. As described earlier, the voupon may originate from any of the partner sites 30, 31, 32 or 38, or may originate from the VRCD database host 20. Once the voupon is downloaded to the user's equipment (10, 15 or 18), it may then be downloaded onto a smartcard device 1300. A variety of methods may be used to convert the voupon into a format that is acceptable for the smartcard 1300. In one embodiment, the voupon arrives at the user's equipment in the form of an e-mail. Upon arriving at the user's equipment, the relevant information is stripped from the text of the e-mail message and is placed in a queue so that it may later be stored in a smartcard device 1300. At such time as when a smartcard device 1300 is coupled to a smartcard interface 1305, the voupon information stored in the queue (which may include more than one voupon) is transferred to the smartcard 1300. After the voupon has been transferred to the smartcard device 1300, it may be redeemed in a variety of ways. In one embodiment, the smartcard 1300 may be presented at a merchants' establishment, whereby it may be processed by a merchant's POS device 1310. When being processed by a merchant's POS device 1310, information regarding the redemption of the voupon may be rewritten to the smartcard device 1300. This information may be subsequently transmitted back to a partner site 30, 31, 32, 38 or database host 20 when the smartcard 1300 is resynchronized with the smartcard interface 1305.

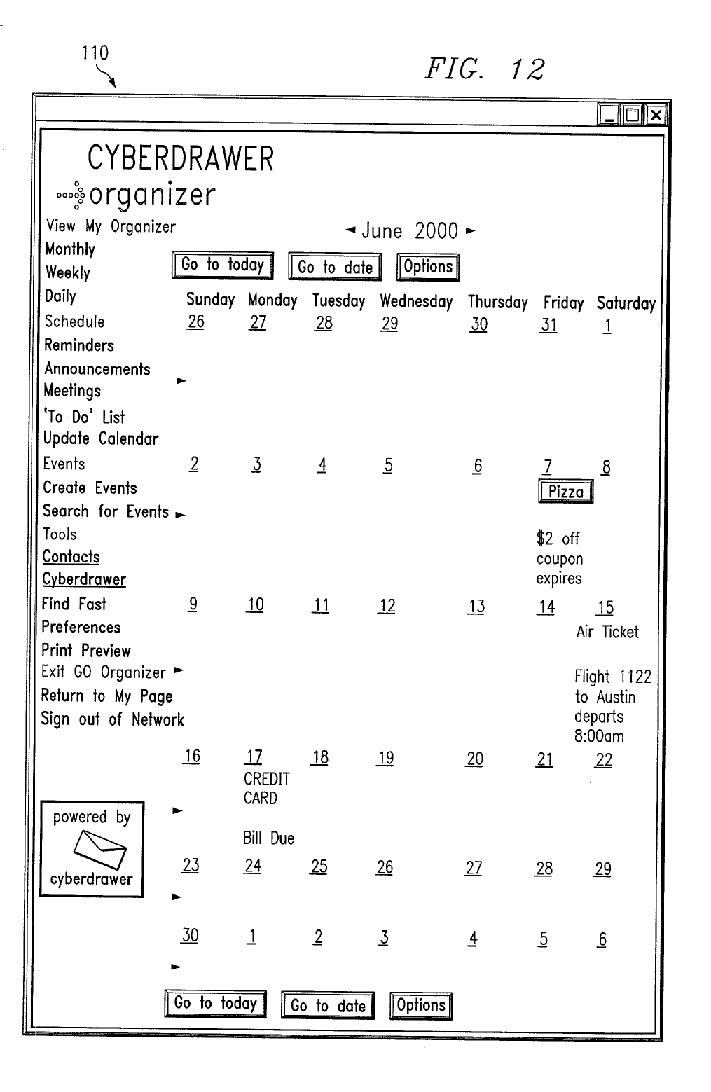

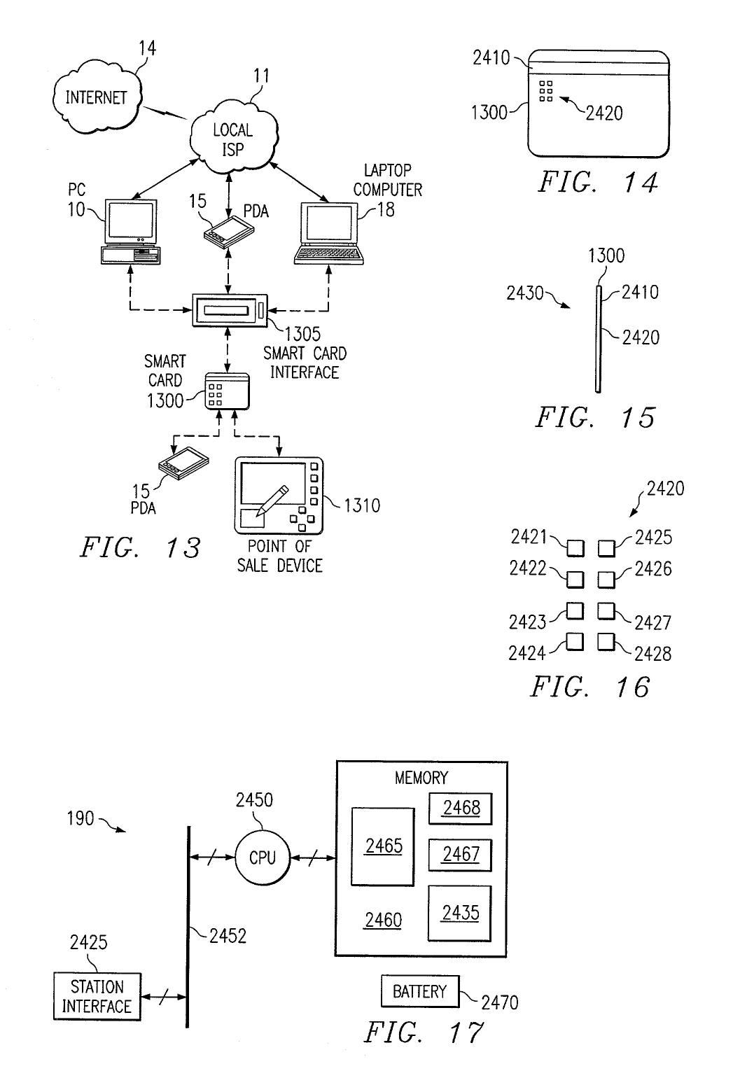

In another embodiment, the voupon may be downloaded from the smartcard 1300 into a PDA 15 so that it can be redeemed. This embodiment allows the voupon to be redeemed in a variety of way including transfer to a merchant's PDA, synchronization of a user's PDA 15 with a merchant's POS device 1310, or redemption at a merchant's Internet web site accessible by the user's PDA 15. A representative smartcard 1300 suitable for use with the invention is depicted in FIG. 14. The use of smart cards can be incorporated into the VRCD distribution system such that when a user selects a coupon offer, or other promotional offer, an electronic file corresponding to the offer is forwarded to the host computer 20. Upon being received at the host computer 20, the electronic file would then be transmitted to the user computer where it would be stored in an electronic queue or weigh station. The file would remain in the queue until a smart card is docked with the smart card interface. At this point, the file (coupon offer) would be automatically downloaded into the smart card. These steps would be transparent to the user. In other words, the only steps visible to the user would be to select the offer for downloading and to insert the smart card into the smart card reader.

FIG. 14 depicts a smart card 1300 suitable for use with the disclosed invention. FIG. 15 depicts a side view of the smart card 1300. Smart card 1300 is typically 8.5 cm by 5.4 cm, the length and width of a typical financial credit card. The smart card 1300 is slightly thicker than a typical financial credit card, however. Smart card 1300 includes a magnetic stripe 2410, interface contacts 2420 for communication with a smart card interface 1305 or point of sale device 1310. Smart card 1300 also includes an embossed area 2430 for displaying the card owner's name. The smart card 1300 may also include a magnetic stripe 2410, which allows a conventional credit card stripe reader to read basic data from the card.

FIG. 16 shows the interface contacts 2420 in more detail. The interface contacts 2420 are configured in accordance with IS07816-2: 1988(E), Identification cards—Integrated circuit(s) cards with contact—Part 2: Dimensions and locations of the contacts, promulgated by the International Organization for Standardization (ISO), and available from the American National Standards Institute (ANSI), 11 West 42nd Street, New York, N.Y. 10036. According to ISO 7816-2, contact 2421 is assigned to VCC (supply voltage), contact 2422 is assigned to RST (reset signal), contact 2423 is assigned to CLK (clock signal), contact 2424 is reserved for future use, contact 2425 is assigned to GND (ground), contact 2426 is assigned to VPP (program and voltage), contact 2427 is assigned to I/O (data input/output), and contact 2428 is reserved for future use. In one embodiment of the invention, the smart card 1300 communicates with the interface 1305 and the point of sale devices 1310 through contact 2427 using a half duplex scheme, meaning that contact 2427 is for communicating data signals either to or from the smart card 1300.

FIG. 17 depicts a block diagram of smart card 1300, including central processing unit 2450, memory 2460, and battery 2470 for supplying power to the station interface 2425, processor 2450, and memory 2460. Memory 2460 is a random access, addressable device. Station interface 2425 includes a serial to parallel converter for transferring data signals between contact 2427 and CPU 2450 over parallel bus 2452. Memory 2460 stores a program 2465 executed by processor 2450, customer identification data 2467, and authorization data 2468. Customer identification data 2467 includes a sequence of digits that uniquely identifies the holder of the card. Customer identification data 2467 may include data such as the cardholder's social security number. For example, identification data 2467 in smart card 1300 uniquely identifies a user 19. Authorization data 2468 also includes date data indicating an expiration date for the smart card 1300. Authorization data 2468 also contains a field identifying that the card is a smart card 1300. Memory 2460 may be used to store a wide variety of VRCD related data 2435, such as electronic coupons in coupon list, and i-PIM data.

Although the various methods described herein have been described for implementation in a general purpose computer selectively activated or reconfigured by software, one of ordinary skill in the art would also recognize that such methods may be carried out in hardware, in firmware, or in more specialized apparatuses constructed to perform the methods. Further, as used herein, a “client” should be broadly construed to mean any computer or component thereof directly or indirectly connected or connectable in any known or later-developed manner to a computer network, such as the Internet. A “client” should also be broadly construed to mean one who requests or gets the file, and the “server” is the entity that downloads the file. Applicant intends that the claims shall not invoke the application of 35 U.S.C § 112, ¶6 unless the claim is explicitly written in means-plus-step or means-plus-function format.

What is claimed is:

1. A method of managing virtual documents on behalf of users, wherein a given virtual document has associated therewith an attribute file, the method comprising:
a) establishing a user database on a network-connected computer, said user database having a set of categories;
b) receiving at least one of said virtual documents and its associated attribute file at said network-connected computer from an interactive television partner computer;
c) categorizing said at least one virtual document according to its associated attribute file; and
d) storing information from said at least one virtual document in one of said set of categories within said user database according to information within said attribute file.

2. The method of claim 1 wherein at least one of said virtual documents is a merchant coupon.

3. The method of claim 1 wherein at least one of said virtual documents is selected from the group consisting of: merchant coupons, product warranties, sales receipts, product instructions, service instructions, rebates, gift certificates, product registration cards, event tickets, credit card statements, bank statements, and recipes.

4. The method of claim 1 wherein said user database is associated with an individual interactive television user.

5. The method of claim 4 and further comprising sending one of said virtual documents from the interactive television partner computer to said network-connected computer upon a request sent from the interactive television user to the interactive television partner computer.

6. The method of claim 5 wherein the interactive television user requested the virtual document from the interactive television partner computer by selecting a banner ad displayed at the user's interactive television receiver.

7. The method of claim 6 wherein the interactive television user requested the virtual document by selecting a button within said banner ad.

8. A database host for managing virtual documents on behalf of users, wherein a given virtual document has associated therewith an attribute file, the database host connected to a network and comprising:
a) a user database having a set of categories;
b) a network interface connected to said network, the network interface configured to receive electronic messages from an interactive television partner computer, said messages comprising said virtual documents;
c) a main server and associated software connected to said network interface and configured to receive one of said virtual documents and to categorize said virtual documents according to data provided in the virtual document's associated attribute file, thereby parsing information elements from said virtual documents; and
d) a database manager connected to said user database and said main server, said database manager configured to receive said information parsed by said main server and to store said information in categories in said user database according to parsing instructions from the main server.

9. The database host of claim 8 wherein said network interface, said main server, and said database manager are all processes running on a single server unit.

10. The database host of claim 8 wherein at least one of said virtual documents is a merchant coupon.

11. The database host of claim 8 wherein at least one of said virtual documents is selected from the group consisting of: merchant coupons, product warranties, sales receipts, product instructions, service instructions, rebates, gift certificates, product registration cards, event tickets, credit card statements, bank statements, and recipes.

12. The database host of claim 8 wherein said user database is associated with an individual interactive television user.

13. The database host of claim 8 wherein said electronic messages further include user preference information from said users.

14. The database host of claim 8 and further comprising a web server connected to said main server and configured to display web pages accessible by said other network-connected computers.

15. The database host of claim 14 wherein said web server is a software process running on the same server unit as said main server.

16. A method of managing virtual documents on behalf of users, wherein a given virtual document has associated therewith an attribute file, the method comprising:
a) establishing a user database on a network-connected computer, said user database having a set of categories;
b) receiving a request for a virtual document at said network-connected computer from an interactive television partner computer;
c) retrieving and categorizing said at least one virtual document according to its associated attribute file at the network-connected computer; and
d) storing information from said at least one virtual document in one of said set of categories within said user database according to information within said attribute file.

17. The method of claim 16 wherein at least one of said virtual documents is a merchant coupon.

18. The method of claim 16 wherein at least one of said virtual documents is selected from the group consisting of: merchant coupons, product warranties, sales receipts, product instructions, service instructions, rebates, gift certificates, product registration cards, event tickets, credit card statements, bank statements, and recipes.

19. The method of claim 16 wherein said user database is associated with an individual interactive television user.

20. The method of claim 19 wherein the interactive television user requests the virtual document by selecting a banner ad displayed at a user's interactive television receiver.

21. The method of claim 20 wherein the interactive television user requests the virtual document by selecting a button within said banner ad.

22. A database host for managing virtual documents on behalf of users, wherein a given virtual document has associated therewith an attribute file, the database host connected to a network and comprising:
a) a user database having a set of categories;
b) a network interface connected to said network, the network interface configured to receive electronic messages from an interactive television partner computer, said messages comprising said virtual documents;
c) a main server and associated software connected to said network interface and configured to receive a request for one of said virtual documents and to retrieve and categorize said virtual documents according to data provided in the virtual document's associated attribute file, thereby parsing information elements from said virtual documents; and
d) a database manager connected to said user database and said main server, said database manager configured to receive said information parsed by said main server and to store said information in categories in said user database according to parsing instructions from the main server.

23. The database host of claim 22 wherein said network interface, said main server, and said database manager are all processes running on a single server unit.

24. The database host of claim 22 wherein at least one of said virtual documents is a merchant coupon.

25. The database host of claim 22 wherein at least one of said virtual documents is selected from the group consisting of: merchant coupons, product warranties, sales receipts, product instructions, service instructions, rebates, gift certificates, product registration cards, event tickets, credit card statements, bank statements, and recipes.

26. The database host of claim 22 wherein said user database is associated with an individual interactive television user.

27. The database host of claim 22 wherein said electronic messages further include user preference information from said users.

28. The database host of claim 22 and further comprising a web server connected to said main server and configured to display web pages accessible by said other network-connected computers.

29. The database host of claim 28 wherein said web server is a software process running on the same server unit as said main server.

30. A method of distributing a virtual document to a user, wherein the virtual document has associated therewith an attribute file, the method comprising:
establishing a user database on a host computer that is connected to a network, said user database having a set of categories;
in response to a request from a user, receiving a virtual document and an associated attribute file at the host computer from a partner computer that is connected to the network;
categorizing the virtual document according to its associated attribute file;
transmitting the virtual document to the user through the network;
receiving and storing the virtual document at a user computer; and
downloading the virtual document onto a smart card device.

31. A method according to claim 30, wherein the step of transmitting the virtual document is performed by sending an e-mail to the user.

32. A method according to claim 30, wherein the user computer is a personal digital assistant.

33. A method according to claim 30, wherein the user computer is a personal computer.

34. A method according to claim 30, wherein the step of downloading the virtual document onto the smart card device is performed in response to the connection of the smart card device to a smart card interface.

35. A method according to claim 30, wherein the virtual document comprises a merchant coupon.

36. A method according to claim 35, further including the step of:
redeeming the virtual document at a merchant location by connecting the smart to a merchant smart card interface.

37. A method according to claim 36, wherein the merchant smart card interface comprises a personal digital assistant.

38. A method of distributing a virtual document to a user, wherein the virtual document has associated therewith an attribute file, the method comprising:
establishing a user database on a host computer that is connected to a network, said user database having a set of categories;
receiving a request for a virtual document from a user, the request forwarded to the host computer from a partner computer that is connected to the network;
retrieving the requested virtual document and categorizing it in the host computer according to its associated attribute file;
transmitting the virtual document to the user through the network;
receiving and storing the virtual document at a user computer; and
downloading the virtual document onto a smart card device.

39. A method according to claim 38, wherein the step of transmitting the virtual document is performed by sending an e-mail to the user.

40. A method according to claim 38, wherein the user computer is a personal digital assistant.

41. A method according to claim 38, wherein the user computer is a personal computer.

42. A method according to claim 38, wherein the step of downloading the virtual document onto the smart card device is performed in response to the connection of the smart card device to a smart card interface.

43. A method according to claim 38, wherein the virtual document comprises a merchant coupon.

44. A method according to claim 43, further including the step of:
redeeming the virtual document at a merchant location by connecting the smart card to a merchant smart card interface.

45. A method according to claim 44, wherein the merchant smart card interface comprises a personal digital assistant.

46. A computer program product for use with a general purpose computer, the product encoded with instructions for commanding the computer to perform a series of steps including:
receiving a virtual document and an associated attribute file at a user computer from a host computer that is connected to a computer network;
extracting contact information from the associated attribute file;
extracting at least one date from the associated attribute file;
storing the extracted contact information in a contact database corresponding to a personal information manager program on the user computer;
storing the extracted at least one date in a calendar database corresponding to the personal information manager program on the user computer;
storing the virtual document in a synchronization queue on the user computer; and
downloading the virtual document from the synchronization queue on the user computer to a smart card device.

47. A computer program product according to claim 46, wherein the virtual document and associated attribute file are received by the host computer in the form of an e-mail message.

48. A computer program product according to claim 46, wherein the virtual document is a merchant coupon.

49. A computer program product according to claim 48, wherein the contact information comprises a merchant name, a merchant address, a merchant telephone number, and a merchant web site URL.

50. A computer program product according to claim 48, wherein the at least one date corresponds to an expiration date for the coupon.

51. A computer program product according to claim 50, further encoded with instructions for commanding the computer to create a reminder corresponding to the expiration date in the calendar database corresponding to the personal information manager program on the user computer.

52. A computer program product according to claim 46, further encoded with instructions for commanding the computer to download the virtual document from the synchronization queue on the user computer to the smart card device in response to the connection of the smart card device to a smart card interface, which is connected to the user computer.
